(19) United States
(12) Patent Application Publication
(10) Pub. No.: US 2008/0314823 A1
(43) Pub. Date: Dec. 25, 2008

(54) EXTRUDED LAMELLA SEPARATOR PANEL MODULES

(76) Inventors: Frank M. Kulick, III, Sinking Spring, PA (US); Kerry Dissinger, Sinking Spring, PA (US)

Correspondence Address: MILLER LAW GROUP, PLLC, 25 STEVENS AVENUE, WEST LAWN, PA, 19609, US

(21) Appl. No.: 11/765,958

(22) Filed: Jun. 20, 2007

(51) Int. Cl. B01D 21/02

(52) U.S. Cl. 210/521; 210/532.1; 210/541

(57) ABSTRACT

A lamella panel module is formed from extruded PVC side rails and a plastic plate member secured to the opposing side panels. Each side rail is formed with receiver mounts defining recesses for the mounting of the lamella plates. The plates are preferably affixed to the receiver mounts by adhesives to establish a structurally stable panel module. Each side rail has fore-and-aft opposing mating flanges that prevent horizontal movement of the modules, but allow generally vertical movement to enable any module to be removed from the assembly and replaced. The frame of the lamella separator assembly is formed with a support ledge on the opposing lateral sides of the frame to support a walking grid therebetween. The supported walking grid does not interfere with the flow of clarified water into the collection troughs supported on a vertical member projecting above the support ledge and allows cleaning of the plates.

### FIELD OF THE INVENTION

The present invention generally relates to an apparatus for settling particulates from water through a lamella separator and, more particularly, to the manufacture of improved lamella separator panels.

### BACKGROUND OF THE INVENTION

Sedimentation basins and clarifiers have been used for many years to separate solids suspended in water and wastewater. Lamella plate settlers are a common method for reducing solids concentration in flow through systems. Applications are for settling in the water and wastewater industries to increase the capacity of existing clarifiers, reduced footprint of new construction clarifiers, membrane backwash basins, and/or to reduce the solids load on tertiary equipment such as sand filters.

Lamella separators have been utilized to separate particulate solids from a carrying liquid, such as water or wastewater, by directing the liquid between series of inclined plates. The separated particles settle on the inclined lamella plates and slide down into a hopper area below the lamella plates where the particulates can be removed. The effective settling area of each lamella plate is equivalent to the horizontal projection of that lamella plate; therefore, lamella plates are typically spaced a few inches apart with the result that large settling surfaces are concentrated within a relatively small area. Lamella separators promote laminar and stable flow conditions throughout the apparatus and have been very successful in achieving a high degree of separation of the particulate material, particularly the counter-current flow configuration, which provides an effective and inexpensive apparatus.

The design of lamella separators incorporates a number of design variables which cooperate with one another in determining the efficiency of the apparatus. In designing a lamella separator, it is desirable to maximize effective use of the projected lamella area while preventing sludge that has already settled from being re-entrained in the flow of the water passing upwardly through the lamella separator plates. Further, in order to maximize utilization of the lamella settling surfaces and achieve the greatest possible efficiency, it is important that each lamella flow passage be given a substantially equal hydraulic load. Another important consideration in the design of a lamella separator is the ability to maintain the apparatus. Lamella separator panels must be properly maintained, including cleaning and/or replacement of the lamella plates. Preferably, such maintenance and/or replacement can be accomplished without materially interfering with the operation of separator.

U.S. Pat. No. 4,889,624, issued to Alfonse Soriente on Dec. 26, 1989, discloses a panel for a lamella separator, which is formed from polypropylene structural foam and supported between side plates. Integral lugs are formed into the individual panels so that proper spacing can be maintained between adjacent panels. These structural foam plates are removable from the separator assembly by simply extracting the plate vertically, which would permit the individual plate to be replaced or re-inserted into the separator stack after maintenance has been performed on the plate. Pivotal movement of lamella separator plates is disclosed in U.S. Pat. No. 7,201,849, granted to Alain Boulant on Apr. 10, 2007, by affixing the individual plates on tubular members that are pivotally movable to position the plates between an inclined operative position and a vertical cleaning position.

Extruded side panels for a lamella separator are taught in U.S. Pat. No. 4,681,683, granted on Jul. 21, 1987, to Anders Lindstol. Each pair of opposing side panels carries a single lamella panel between them. The side panels are formed with an interlocking configuration with each side panel being engagable with the side panel both fore and aft, to be able to form a stack of panel members that form the lamella separator. The entire panel stack is removable from the lamella separator by removing the retaining clips keeping the stack of lamella plates in the desired place on the frame assembly.

It would be desirable to provide a lamella separator panel construction that will be lightweight and be easily moved from the lamella separator for maintenance and/or replacement. It would also be desirable to provide a frame for a lamella separator that will facilitate the cleaning of the lamella plates.

### SUMMARY OF THE INVENTION

It is an object of this invention to overcome the disadvantages of the prior art by providing a lamella panel module constructed of polymeric material, such as polyvinylchloride (PVC).

It is an object of this invention to provide a lamella separator formed from modules containing multiple plates affixed between a pair of extruded plastic side rails.

It is a feature of this invention that the extruded plastic side rails are formed with interengagable connecting flanges that allow adjacent panel modules to be latched together for form a freestanding lamella plate assembly.

It is an advantage of this invention that the interengaged connecting flanges prevent individual lamella panel modules from separating in a horizontal direction.

It is another advantage of this invention that the interengaged connecting flanges allow a generally vertical movement of individual lamella panel modules relative to adjacent lamella panel modules.

It is a feature of this invention that the side rails of the lamella panel modules are formed from extruded polymeric material, such as polyvinylchloride (PVC) or other suitable plastic material.

It is another feature of this invention that the side rails are formed with integral plate receiver mounts, each receiver mount having a recess sized to receive a lamella plate.

It is still another advantage of this invention that each side rail is formed with multiple receiver mounts which can be selectively used to mount lamella plates.

It is still another feature of this invention that the lamella panel module will support multiple lamella plates.

It is yet another advantage of this invention that the lamella panel modules are sufficiently lightweight to be easily removed from the lamella separator assembly for service or replacement.

It is yet another feature of this invention that the lamella plates can be secured in the receiver mounts formed in the extruded side rails by adhesives.

It is still another advantage of this invention that the lamella panel module is structurally stable and, depending of the vertical length thereof, can be freestanding.

It is still another feature of this invention that the frame of the lamella separator assembly is formed with a grid support to position a walking grid above the lamella panel modules.

It is a further advantage of this invention that the walking grid supported on the frame of the lamella separator assembly enables an operator to stand over the lamella plates and affect cleaning thereof with a stream of water from a hose.

It is a further feature of this invention that the walking grid is positioned below the level of the discharge weir for the discharge of clarified water into effluent collection troughs for removal from the lamella separator assembly.

It is still a further advantage of this invention that the positioning of the walking grid does not interfere with the discharge of clarified water from the lamella separator assembly.

It is yet another object of this invention to provide a lamella panel module which is durable in construction, inexpensive of manufacture, carefree of maintenance, facile in assemblage, and simple and effective in use.

These and other objects, features and advantages are accomplished according to the instant invention by providing a lamella panel module that is formed from extruded PVC side rails and a plastic plate member secured to the opposing side rails. Each extruded side rail is formed with a plurality of receiver mounts defining recesses for the mounting of the plastic lamella plates. The plates are preferably affixed to the receiver mounts by adhesives to establish a structurally stable panel module. Each side rail has fore-and-aft opposing mating flanges that prevent horizontal movement of the modules, but allow generally vertical movement to enable any module to be removed from the assembly and replaced. The frame of the lamella separator assembly is formed with a support ledge on the opposing lateral sides of the frame to support a walking grid therebetween. The supported walking grid does not interfere with the flow of clarified water into the collection troughs supported on a vertical member projecting above the support ledge and allows cleaning of the plates.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a perspective view of the frame for the lamella separator assembly incorporating the principles of the instant invention;

FIG. 2 is a side elevational view of the frame shown in FIG. 1;

FIG. 3 is a front elevational view of the frame depicted in FIG. 1;

FIG. 4 is a perspective view showing the lamella separator assembly incorporating the principles of the instant invention;

FIG. 5 is a side elevational view of the lamella separator assembly shown in FIG. 4;

FIG. 6 is a front elevational view of the frame of the lamella separator assembly depicting the walking grid and the discharge troughs supported on the frame;

FIG. 7 is a perspective view of an individual lamella panel module incorporating the principles of the instant invention;

FIG. 8 is a side elevational view of the lamella panel module depicted in FIG. 7;

FIG. 9 is an exploded view of the lamella panel module depicted in FIG. 7;

FIG. 10 is an elevational view of a side rail forming part of the lamella panel module;

FIG. 11 is a cross-sectional view of the side rail taken along lines 11-11 of FIG. 10;

FIG. 12 is an exploded cross-sectional view of the lamella panel module;

FIG. 13 is a perspective view of a module stack depicting a configuration in which the modules can be arranged to form an array of lamella plates in a separator assembly;

FIG. 14 is a cross-sectional view similar to the view of FIG. 11, but showing the configuration depicted in FIG. 13, portions of the plates being removed for purposes of clarity;

FIG. 15 is an enlarged cross-sectional view of the end side rail and assembled plates corresponding to circle 5 in FIG. 14;

FIG. 16 is an enlarged cross-sectional view of the opposing end side rail and assembled plates corresponding to circle 6 in FIG. 14; and

FIG. 17 is an enlarged cross-sectional view of the center rail support and assembled plates corresponding to circle 7 in FIG. 14.

### DETAILED DESCRIPTION OF THE PREFERRED EMBODIMENT

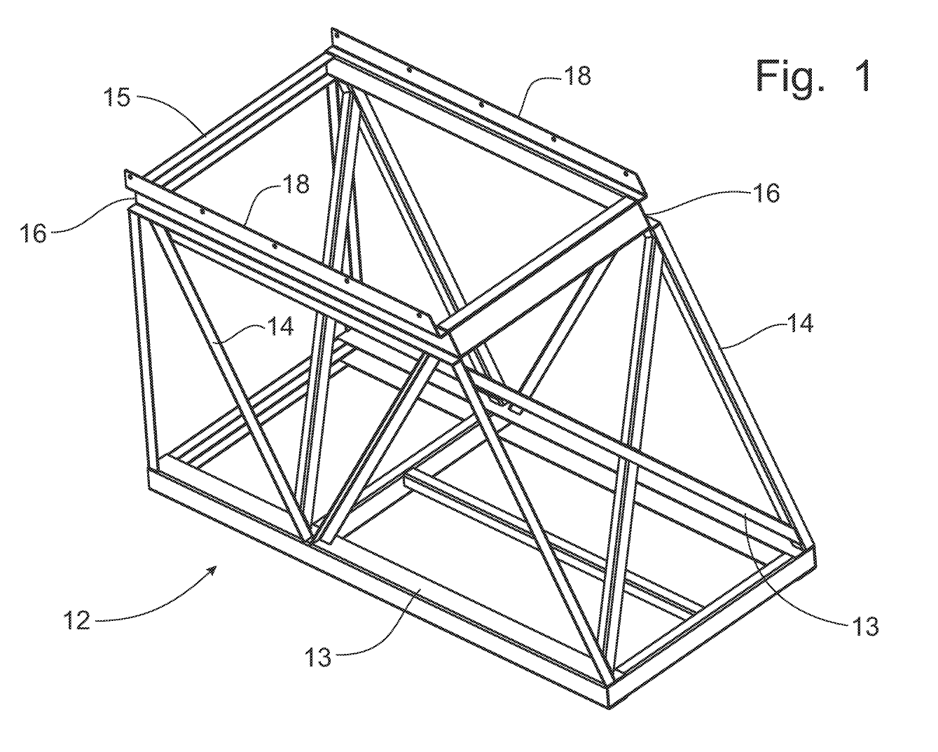

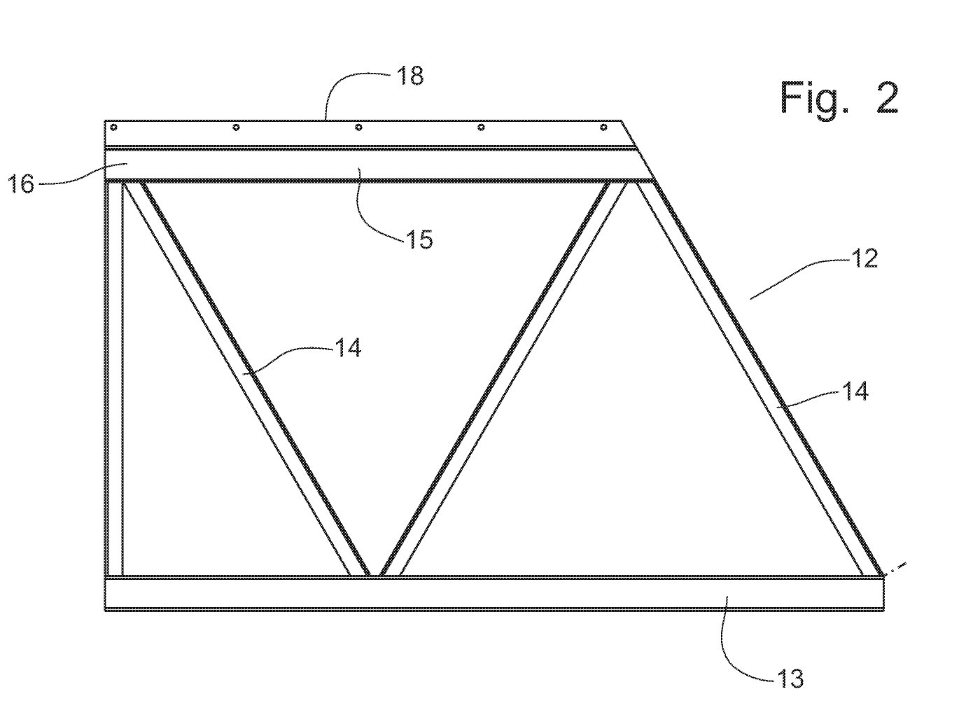

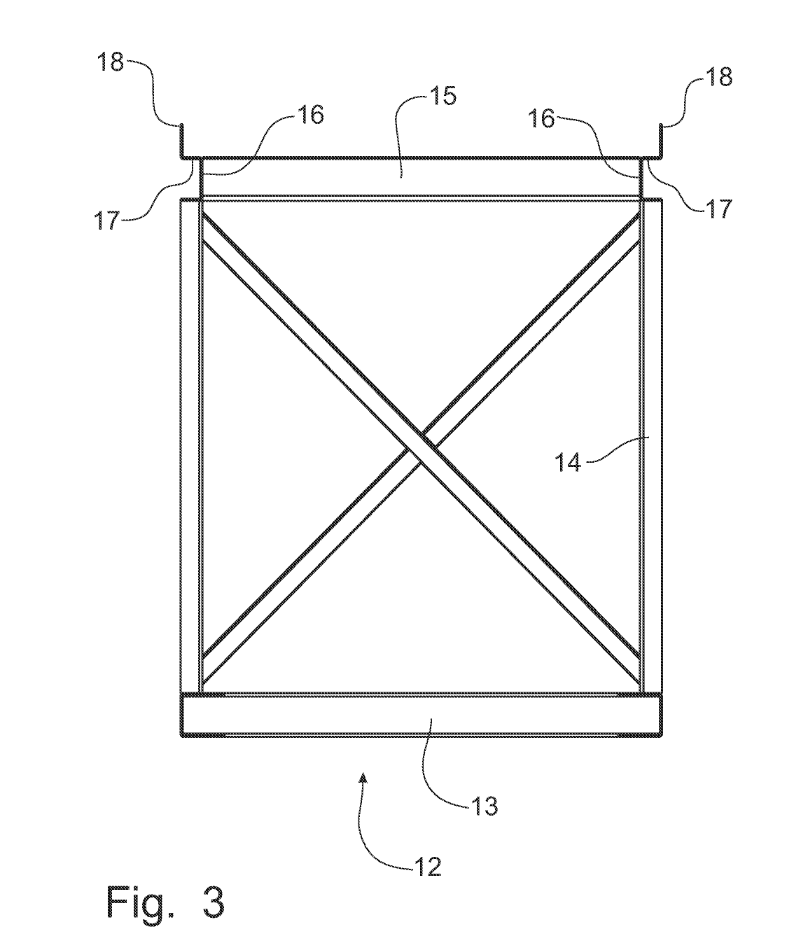

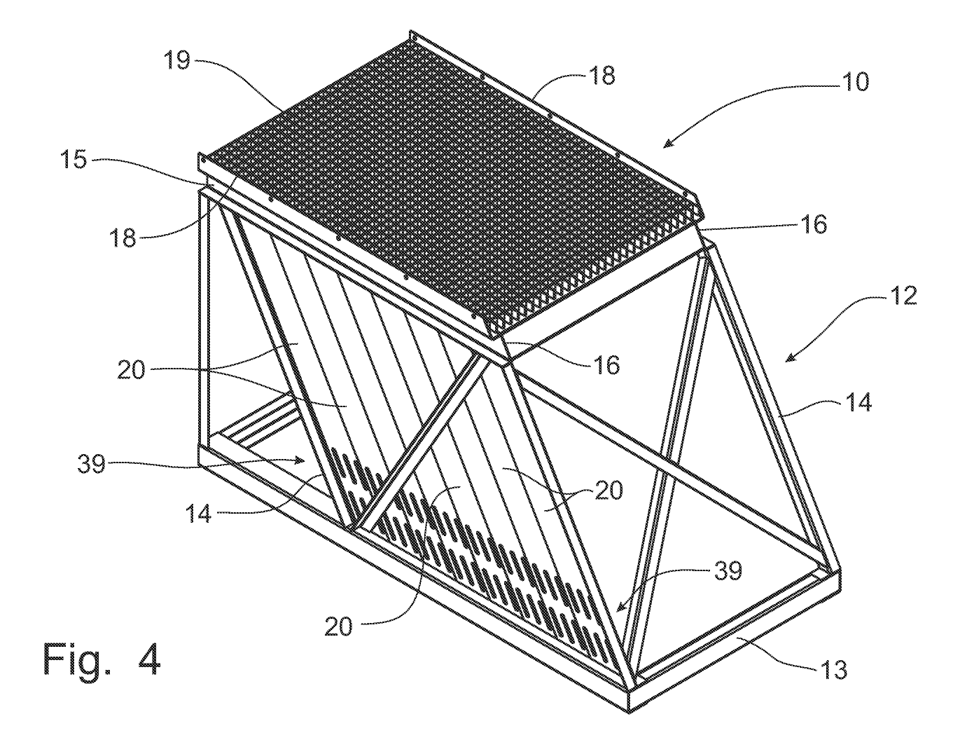

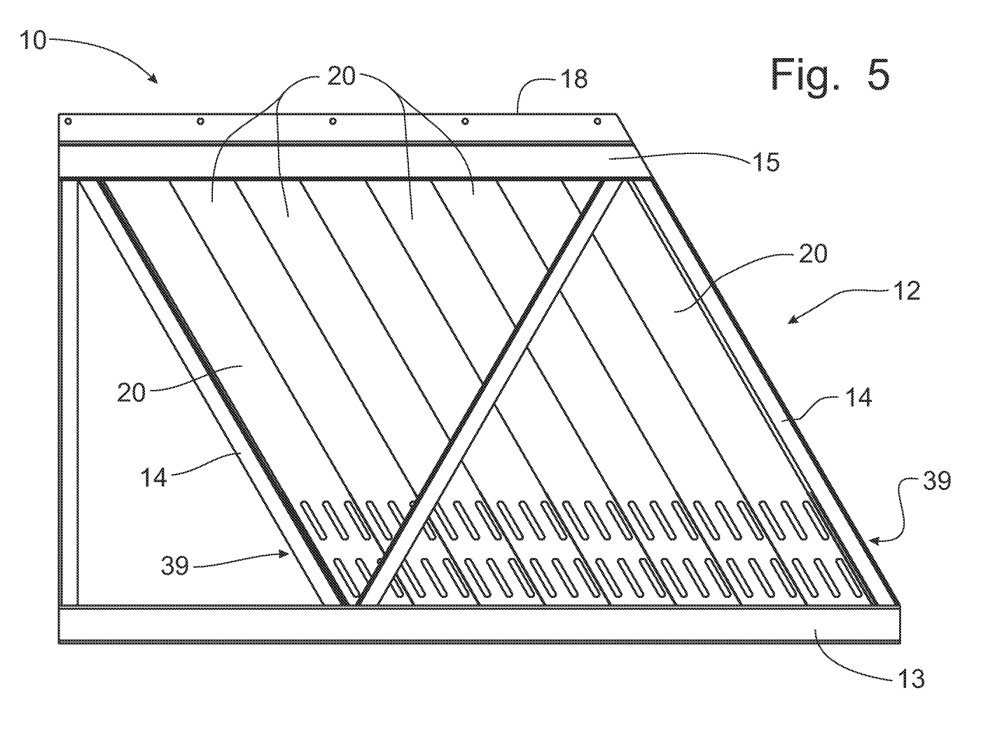

Referring first to FIGS. 1-6, a frame for a lamella separator incorporating the principles of the instant invention can best be seen. The lamella separator 10 is a known apparatus that directs the flow of wastewater upwardly between inclined lamella plates 25 while the suspended particulate matter within the wastewater precipitates out of the flow of the wastewater and collects on the inclined plates 25 to slide by gravity down the plates 25 to be collected at the bottom of the assembly 10. The frame 12 of the lamella separator assembly 10 is formed with lower horizontal support members 13 to permit the lamella separator 10 to sit on a horizontal support, such as transverse supports (not shown) within a clarifier tank (not shown), to position the lamella separator 10 at some level above the floor of the clarifier tank, and to provide support for the lamella plates 25 as will be described in greater detail below. The frame 12 also has inclined support members 14 on which the lamella panel modules 20 recline to support the modules 20 so that the plates 25 are disposed at the proper inclined angle.

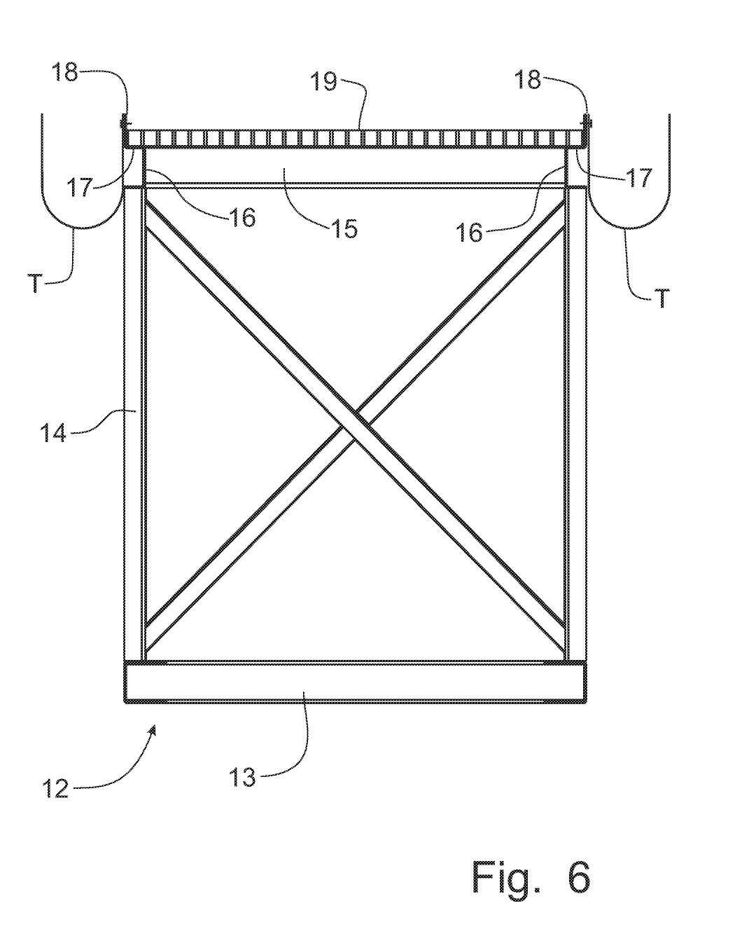

The frame 12 also includes an upper support structure 15 which is oriented generally horizontally, parallel to the lower support members 13. The upper support structure 15 includes a formed channel support member 16 that forms a generally horizontal ledge 17 on which a walking grid 19 can be mounted. The formed channel 16 also includes a vertical support member 18 that projects upwardly from the ledge surface 17 to support an appropriate collection trough T into which the clarified water will pass, as best seen in FIG. 6, to be removed from the lamella separator assembly 10 and the clarifier tank (not shown). The discharge of clarified water into the collection trough T can be controlled by the trough T via a known V-notch weir arrangement. The lamella panel modules 20 as will be described in greater detail below, are oriented so that the plates 25 are angled to vertical at about thirty degrees such that the water flowing upwardly is directed to the underside of the plates 25 while the particulates settling out of the water flow fall onto the upper side of the adjacent plate 25. The lamella panel modules 20 rest on the lower support members 13 and recline against the inclined support members 14.

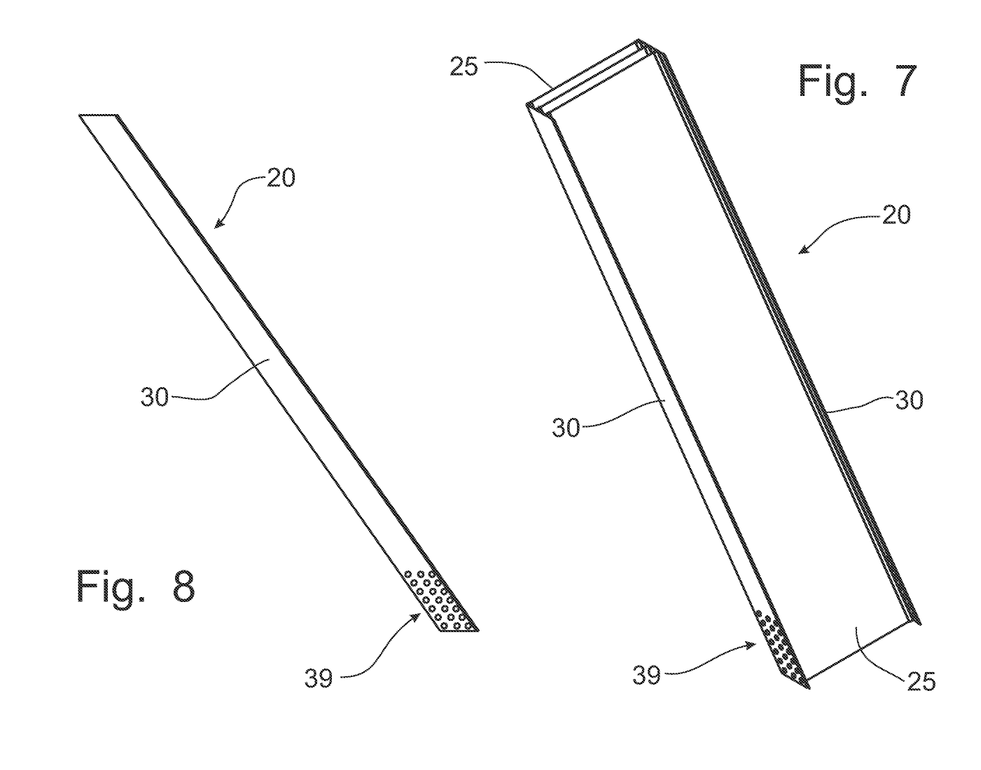

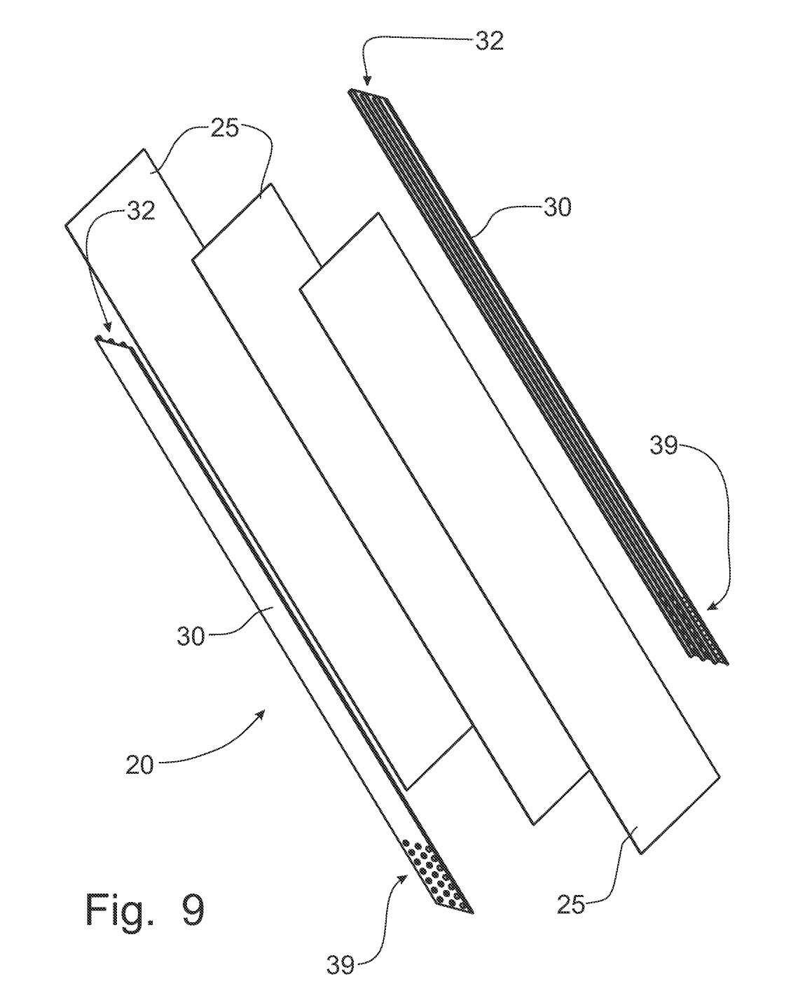

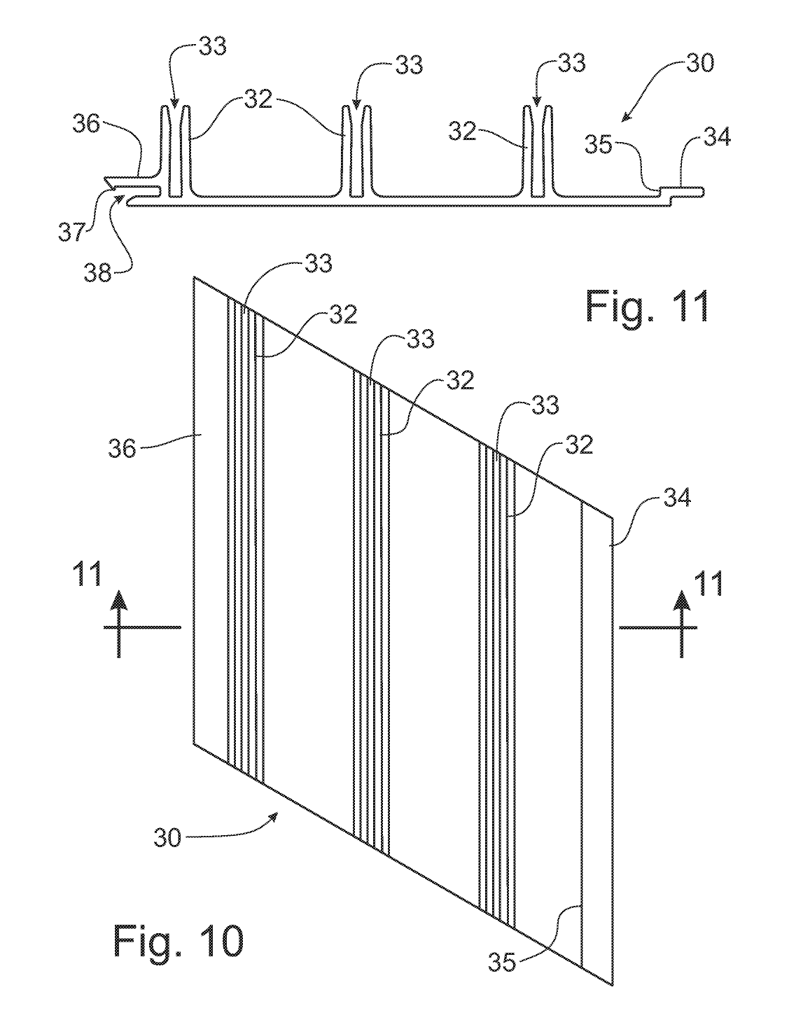

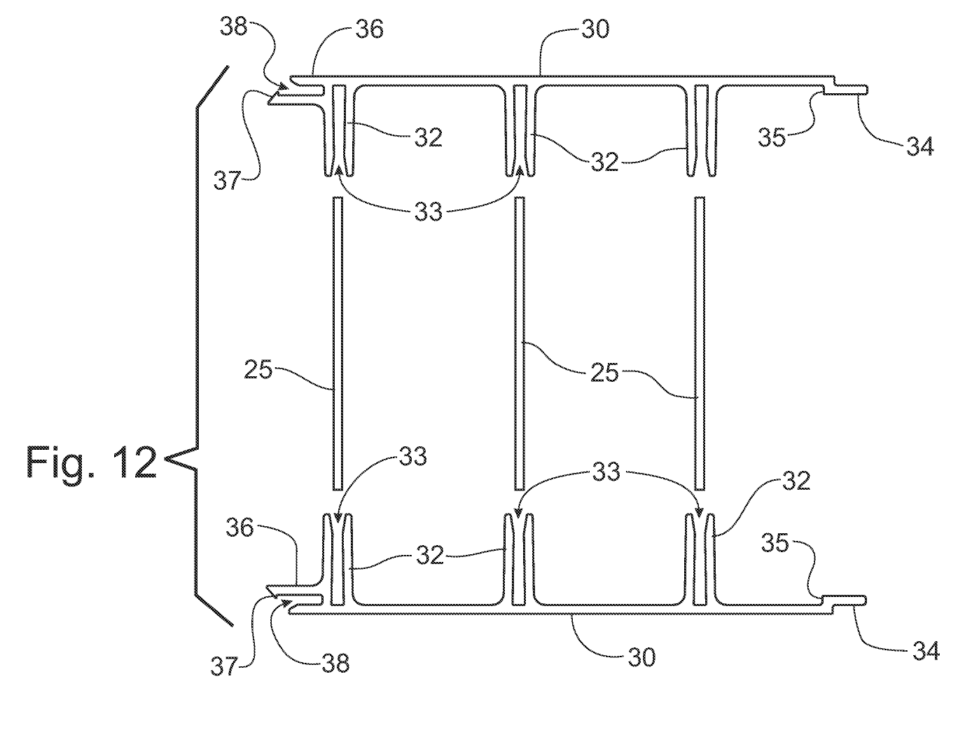

The individual lamella panel modules 20 are best seen in FIGS. 7-12. The lamella panel module 20 uses a pair of profile-extruded side rails 30 to support flat sheet material as the plates 25 in a parallel array. In general, each side rail 30 is constructed of profile-extruded polymeric material, such as polyvinylchloride (PVC), but is not limited to this material, and the plates 25 are preferably flat PVC sheeting. The thickness of each plate 25 is preferably about ⅛″. Each side rail 30 is formed with a plurality of receiver mounts 32 on one side of the side rail 30 oriented such that the horizontal spacing between successive plates 25 is substantially constant throughout the assembly 10 from one module 20 to the next module 20

Each receiver mount 32 is formed with a recess 33 that is formed to receive the plates 25 securely within the receiver mount 32. Each plate 25 can be glued within the recess 33 to keep the plate from being disengaged from the corresponding side plate 30. Each receiver mount 32 is integrally formed with the side rail 30 and project inwardly toward the opposing side rail 30 approximately 1″ in height so as to locate and attach the flat sheet plate 25 and to provide structural integrity for the assembled panel module 20, providing a plurality of plates 25 attached to the side rails 30 in consistent intervals of approximately 2″ for water treatment and 3″ for wastewater treatment. The flat sheet plates 25 are attached through a solvent bond or glue to the receiver mounts 32 to prevent the settled solids loading onto the plate 25 from the upwardly moving water from pulling the sheet from the receiver mounts 32. The length of the side rails 30 is defined by the depth of the basin and angle of repose, typically between 55 and 60 degrees. The width of the flat sheet plate 25 extending between the opposing side rails 30 is defined by the basin width as the arrangement must include the system of plates 25 and troughs T for treatment and typically will have symmetry about the center of the lamella separator assembly 10.

The lamella panel module 20 is preferably formed with three plates 25 and two side rail extrusions 30. Each side rail 30 is formed with standard holes or slots 39 positioned near or at the bottom of the side rail extrusions 30 at the interface with incoming flow of water to be directed upwardly through the separator assembly 10. The holes or slots 39 reduce the velocity of the fluid entering the bottom of the plates 25 as to reduce re-entrainment of settled solids on the surface of the plate 25. The modules 20 are installed into the support frame 12 and suspended above the floor of the basin into which the separator assembly 10 is installed.

While the preferred number of receiver mounts 32 is three on the inside surface of each side rail 30, the number of receiver mounts 32 could be significantly higher. Furthermore, not all of the receiver mounts 32 needs to be utilized in every lamella separator 10 configuration to support an inclined plate 25. For example, each side rail 30 could be formed with six receiver mounts 32 spaced one inch apart so that selective ones of the receiver mounts 32 could be utilized to form a panel module 20 with plates 25 spaced at either two inches or at three inches, or even at six inches if only one of the opposing pairs of receiver mounts 32 are utilized on the opposing side rails 30.

Each side rail 30 is also formed with connector flanges 34, 36 extending along the vertical edges thereof. The male connector flange 34 is located at one edge while the female connector flange 36 is located on the opposing edge. A plurality of modules 20 make up a fully assembled lamella separator assembly 10. The male connector flange 34 on one module side rail 30 being received within the female connector flange 36 of the adjacent module side rail 30. Each female connector flange 36 is formed with a restraining protrusion 37 that extends generally perpendicularly to the recess 38. The restraining protrusion 37 is engagable with a plateau 35 formed by a bend in the male connector flange 34 interlocking the engaged male and female connector flanges 34, 36 to provide stability and co-located support. This interlocking male and female connector flanges 34, 36 eliminates the effects of the bottom “kicking out” from underneath the individual modules.

As will be understood by one of ordinary skill in the art, the male and female connector flanges 34, 36 can be snapped together by moving the male and female connector flanges 34, 36 together generally horizontally. In such a process, the male connector flanges 34 deflects the restraining protrusion 37 until the protrusion 37 passes by the plateau 35 and then snaps into place. Once connected together, the interlocking connector flanges 34, 36 prevent a horizontal disengagement of adjacent modules 20, unless sufficient force is asserted to cause the restraining protrusion 37 to deflect away from and release the plateau 35 on the male connector flange 34; however, the linear nature of the respective connector flanges 34, 36 allow generally vertical movement of one module 20 relative to the engaged adjacent module 20 to permit the module 20 to slide upwardly along the adjacent module 20. In this manner, any specific module 20 can be removed from the stack of modules 20 forming the separator assembly 10, and subsequently replaced, thereby allowing repair or replacement of the selected module 20. Furthermore, the interlocking male and female connector flanges 34, 36 also provide for ease of assembly as each module 20 is simply locked into place with the preceding module 20. This modular concept allows for variable design with respect to tank dimensions and integration with overflow troughs T.

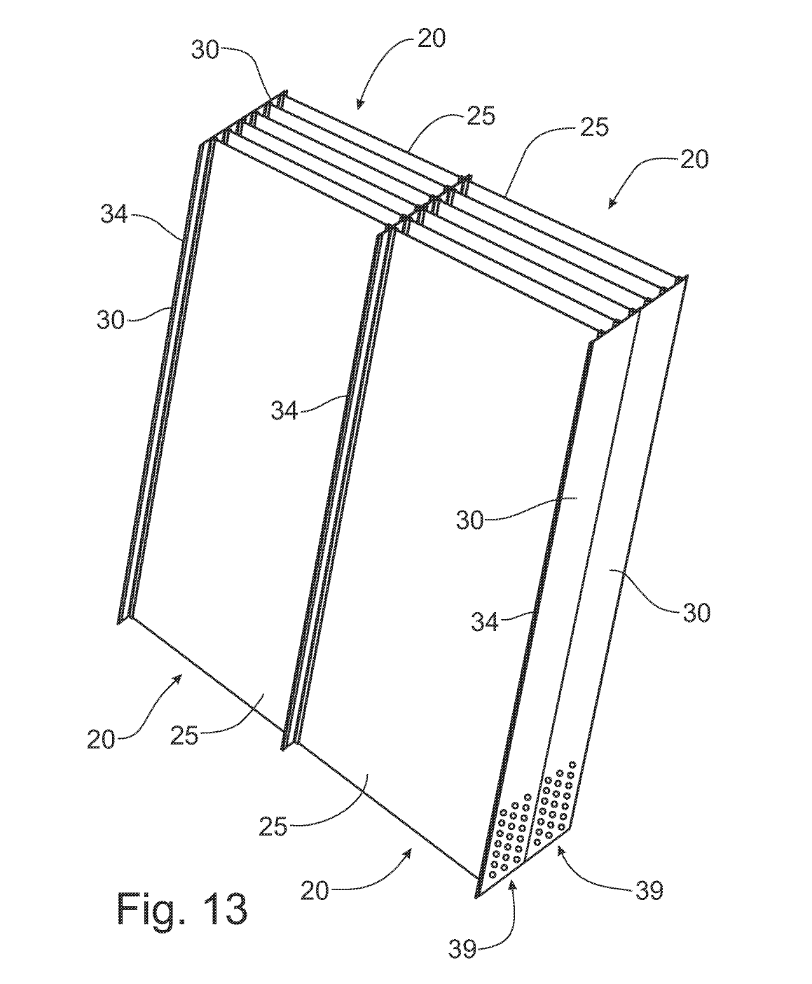

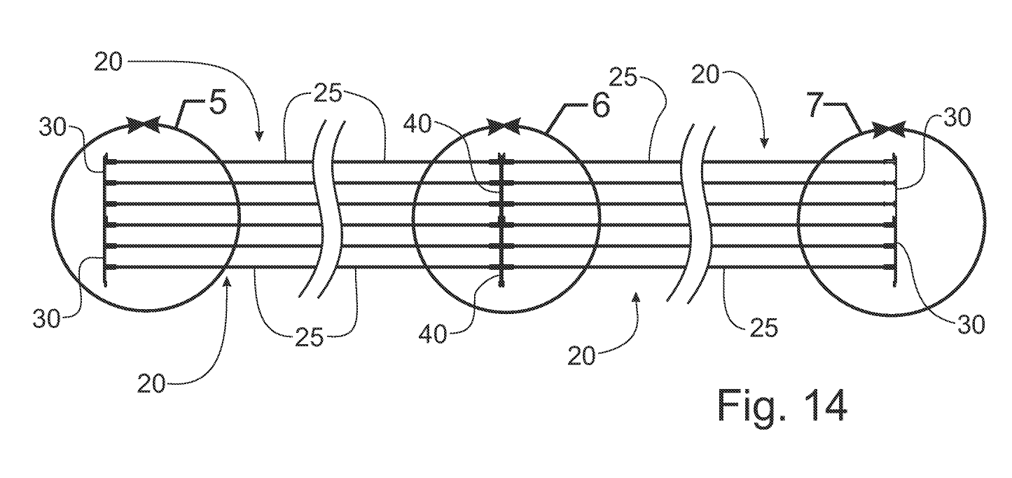

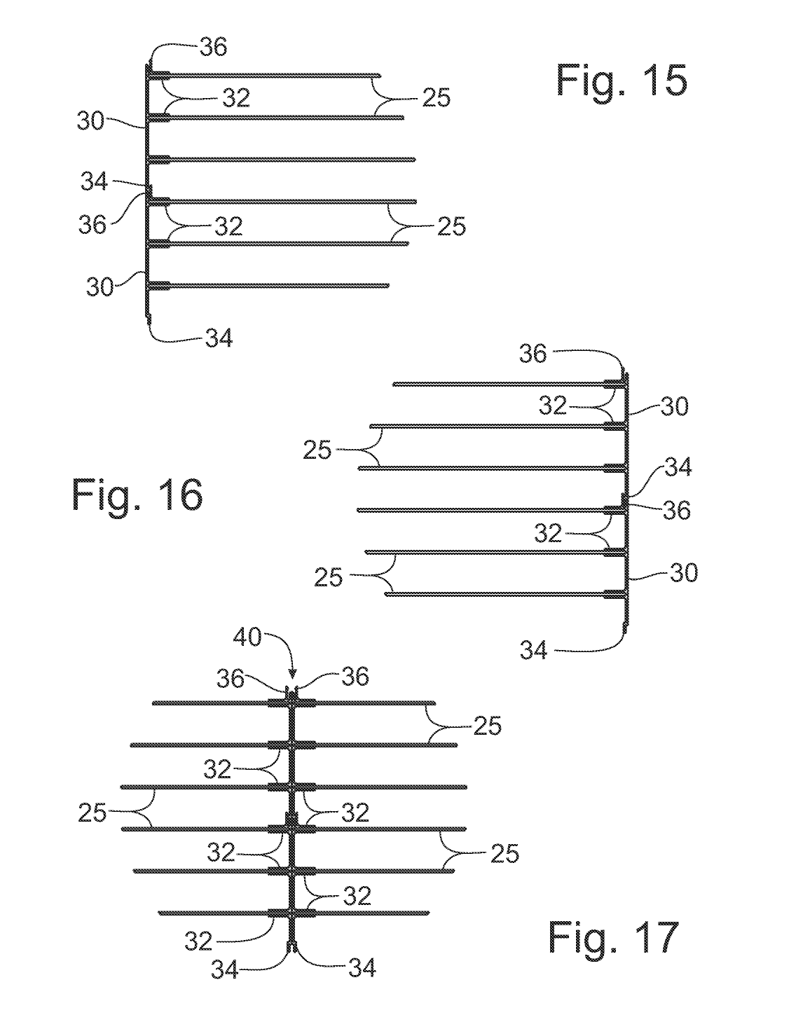

Referring now to FIGS. 13-17, an alternative configuration for the array of plates 25 for a lamella separator assembly 10 can best be seen. With the side rails 30 and plates 25 formed of plastic, such as PVC, the maximum practical operative width of a plate 25 is approximately 30 inches. If the operative width for the plates 25 in a separator assembly 10 is desired to be 60 inches, a center rail support 40 can be positioned midway across the module 20 to support opposing ends of plates 25 affixed to the opposing side rails 30. The center support rail 40 can be formed from a pair of side rails 30 placed back-to-back and preferably adhered together, as is depicted in FIGS. 13-17, or the center support rail 40 can be a separate unitary extrusion with receiver mounts 32 positioned on both sides thereof and male and female connector flanges located on the fore-and-aft edges.

FIGS. 13-17 also depict the manner in which separate modules 20 are interconnected. Whether or not the module 20 includes a center support rail 40, the side rails 30 are connected end-to-end with the male connector flange 34 of one module 20 being engaged with the female connector flange 36 of the other module 20. One skilled in the art will recognize that this interconnection of modules 20 can continue until an entire separator assembly 10 is constructed with the plates 25 placed into a uniformly spaced inclined array. Since the connector flanges 34, 36 allow generally vertical movement with the restraining protrusion 37 sliding over the engaged plateau 35, a centrally positioned panel module 20 can be lifted out of the assembly 10 without disturbing the positioning of the other modules 20, thus allowing the displaced module to be repaired or simply replaced by sliding the new or repaired panel module 20 back into location engaged with the adjacent modules 20.

In operation, the infeed of water to be clarified enters at one end of the basin (note shown), travels under and around the sides of the lamella separator assembly 10, through the holes in the side rails 30 and the bottom opening (due to the modules 20 being supported above the floor of the basin on the lower horizontal frame members 13, up though the plates 25, to the top of the lamella separator assembly 10 to discharge over the vertical supports 18 above the channel supports 16, and into the effluent troughs T.

The frame 12 is designed to support the integrated parts of the plate settler assembly. In this design, the formed channel support 16, serving as the top frame rail, serves several functions. Primarily, the formed channel 16 completes the structural frame 12 to support and distribute the lamella panel modules 20 within the settling basin (not shown). The formed channel support 16 also supports the top grating 19 used to access the modules 20. The grating 19 is able to support the weight of an operator to wash down any solids accumulated on the plates 25 during normal operation of the separator assembly 10. The channel support 16 also provides a means to attach the effluent or overflow troughs T via fasteners engaged with the vertical support member 18.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A lamella separator operable to settle solids from a flow of liquid carrying the solids along an array of inclined plates, comprising:
a frame having lower frame members, upper frame members and inclined frame members extending between said upper and lower frame members; and
a plurality of panel modules supported on said lower frame members, each said panel module including a pair of opposing side rails and at least two said plates extending between said side rails, each said side rail having a male connector flange at one side thereof and a female connector flange at the opposing side thereof, said panel modules being connected by the engagement of the male connector flange of one module moving generally horizontally into the female connector flange of the adjacent module.

2. The lamella separator of claim 1 wherein said female connector flange forms a recess for the reception of said male connector flange, said female connector flange including a restraining protrusion that locks against a plateau formed in said male connector flange to secure the two engaged connector flanges together.

3. The lamella separator of claim 2 wherein the engagement of said restraining protrusion and said plateau restricts horizontal movement of one panel module away from the adjacent panel module engaged therewith, said restraining protrusion being generally vertically movable along the corresponding said plateau to permit said one panel module to be disengaged from the adjacent panel module engaged therewith without disturbing the position of the adjacent panel module.

4. The lamella separator of claim 3 wherein said plates are mounted in said side rails to be inclined from a true vertical orientation, said male and female connector flanges being oriented generally parallel with said plates, the generally vertical movement of one panel module relative to the adjacent panel module engaged therewith by said restraining protrusion moving along the corresponding said plateau being in a direction generally parallel to said plates.

5. The lamella separator of claim 2 wherein each said side rail is also formed with a plurality of receiver mounts defining a receiving recess into which said plates are positioned to engage with said side rails, said receiver mounts being located on an inside surface of said side rail.

6. The lamella separator of claim 5 wherein each said side rail is formed with at least three of said receiver mounts positioned such that, when said panel modules are interconnected to form said array of inclined plates, said receiver mounts are uniformly spaced.

7. The lamella separator of claim 6 wherein said side rails are formed from extruded polymeric material.

8. The lamella separator of claim 6 further comprising a center support rail including receiver mounts on both sides thereof corresponding to the receiver mounts on said side rails, said plates extending between each said side rail and said center support rail.

9. The lamella separator of claim 8 wherein said center support rail is formed by attaching two of said side rails such that the receiver mounts thereof extend from both sides thereof.

10. The lamella separator of claim 6 wherein said upper frame members include a formed channel defining a horizontal ledge on which a walking grid can be mounted, and a vertical support member projecting above said formed channel.

11. The lamella separator of claim 10 further comprising a collection trough affixed to each said vertical support member to collect the liquid being discharged from said lamella separator.

12. A panel module for a lamella separator assembly comprising:
a first side rail having on one side thereof a plurality of first inclined receiver mounts defining corresponding first receiving recesses;
a second side rail having on one side thereof a plurality of second inclined receiver mounts defining corresponding second receiving recesses, said first and second receiver mounts projecting toward one another;
at least two transverse plates extending between selected corresponding said first and second receiver mounts;
a male connector on one end of each of said first and second side rails; and
a female connector on a longitudinally spaced opposing end of each of said first and second side rails, said female connector being configured to receive said male connector of an adjacent panel module by engaging said male and female connectors generally horizontally to interconnect successive panel modules.

13. The panel module of claim 12 wherein said female connector forms a recess for the reception of said male connector flange, said female connector including a flange formed with a restraining protrusion that locks against the mating male connector.

14. The panel module of claim 13 wherein said male connector includes a plateau positioned for engagement by said restraining protrusion to secure the two engaged connectors together.

15. The panel module of claim 14 wherein said side rails are formed from extruded polymeric material.

16. The panel module of claim 14 further comprising a center support rail including receiver mounts on both sides thereof corresponding to the receiver mounts on said side rails, said plates extending between each said side rail and said center support rail.

17. A lamella separator operable to settle solids from a flow of water carrying the solids along an array of inclined plates, comprising:
a frame having lower frame members, upper frame members and inclined frame members extending between said upper and lower frame members, said upper frame members including a formed channel defining a horizontal ledge on which a walking grid can be mounted, and a vertical support member projecting above said formed channel to define a discharge edge for water flowing through said separator.

18. The lamella separator of claim 17 further comprising an effluent collection trough affixed to each said vertical support member to collect the water being discharged from said lamella separator, said effluent collection trough establishing said discharge edge.

19. The lamella separator of claim 17 further comprising a plurality of panel modules defining said array of inclined plates, each said panel module comprising:
a pair of opposing side rails having on an inside surface thereof a plurality of inclined receiver mounts defining corresponding receiving recesses, said receiver mounts on said opposing side rails projecting toward one another;
at least two of said inclined plates extending between selected corresponding said receiver mounts;
a male connector on one end of each of said side rails; and
a female connector on a longitudinally spaced opposing end of each of said side rails, said female connector being configured to receive said male connector of an adjacent panel module by engaging said male and female connectors generally horizontally to interconnect successive panel modules.

20. The lamella separator of claim 19 wherein said female connector forms a recess for the reception of said male connector, said female connector including a flange formed with a restraining protrusion that locks against a plateau formed on the mating male connector to secure the two engaged connectors together, said side rails being formed from extruded polymeric material.
